(19) United States
(12) Patent Application Publication
(10) Pub. No.: US 2020/0096462 A1
(43) Pub. Date: Mar. 26, 2020

(54) CONCENTRATION AND TEMPERATURE MEASUREMENT METHOD FOR MAGNETIC NANOPARTICLES BASED ON PARAMAGNETIC SHIFT

(71) Applicant: HUAZHONG UNIVERSITY OF SCIENCE AND TECHNOLOGY, Wuhan (CN)

(72) Inventors: Wenzhong LIU, Wuhan (CN); Silin GUO, Wuhan (CN)

(21) Appl. No.: 16/698,115

(22) Filed: Nov. 27, 2019

Related U.S. Application Data
(63) Continuation of application No. PCT/CN2019/085715, filed on May 6, 2019.

(30) Foreign Application Priority Data
Aug. 10, 2018 (CN) 2018109054645

(51) Int. Cl. G01N 24/08; G01K 7/36

(52) U.S. Cl. CPC G01N 24/082; G01K 7/36

(57) ABSTRACT

The present disclosure discloses a concentration and temperature measurement method for the magnetic nanoparticles based on paramagnetic shift, which measures magnetic nanoparticle concentration and temperature by utilizing a nuclear magnetic resonance device to measure chemical shifts of a liquid sample containing the paramagnetic particles, thereby efficiently achieving high-accuracy concentration and temperature measurement. Paramagnetic magnetic nanoparticles are added to the nuclear paramagnetic resonance sample reagent, and paramagnetic shifts of the sample are obtained by nuclear magnetic resonance. Resonance frequencies are obtained by the paramagnetic shifts, magnetic susceptibilities are obtained according to the relationship between the resonance frequencies and the magnetic susceptibilities of the magnetic nanoparticles, and then the concentration information and temperature information of the sample are obtained by inverse solution according to the relationship between the magnetic susceptibility and the concentration and temperature of the magnetic nanoparticles. From the simulation data, concentration measurement and high-precision temperature measurement of the magnetic nanoparticle samples can be effectively realized by the paramagnetic displacement information.

### BACKGROUND

### Technical Field

The present disclosure relates to the technical field of nano material testing, and in particular to a concentration and temperature measurement method for magnetic nanoparticles based on paramagnetic shift.

### Description of the Related Art

Temperature is an important indicator of life activity, and many diseases can be treated by changing the temperature during medical treatment. Non-invasive visual temperature measurements for living organisms require not only accurate temperature measurements but also accurate positioning of the temperature probe. Magnetic resonance imaging (MM) temperature measurement is a promising temperature measurement method in many non-invasive temperature measurement methods. However, this method is mainly based on the fact that relevant parameters of MRI have the temperature sensibility, and its principle determines that its measurement results will be affected by some temperature-related parameters in human tissues. For example, the presence of fat may cause an error in the temperature estimation, and even if in the same tissue, change in temperature sensitivity coefficient caused by change in tissue structure can cause nonlinear change in temperature value. So far, the spatial resolution of MRI is 1 mm, and the temperature measurement accuracy of MRI is 1° C.

In recent years, temperature measurement methods based on magnetic temperature characteristics of magnetic nanoparticles and magnetic nanoparticle imaging have been rapidly developed. In 2005, B. Gleich and J. Weizenencker used a DC gradient magnetic field to perform spatial coding, and firstly realized magnetic nanoparticle imaging by detecting the magnetization response signal of magnetic nanoparticles under the action of alternating magnetic field and gradient field. In 2009, John. B. Weaver first proposed a method for estimating a temperature using magnetic nanoparticles. In 2011, Liu Wenzhong et al. realized the temperature measurement by measuring the reciprocal of the magnetic susceptibility of magnetic nanoparticles under DC magnetic field. In 2012 and 2013, Liu Wenzhong et al. realized the temperature measurement based on the magnetization of magnetic nanoparticles under the excitation of alternating magnetic field and the temperature measurement based on the magnetization of magnetic nanoparticles under triangular wave excitation.

As a non-toxic substance, magnetic nanoparticles (e.g., iron oxide nanoparticles) provide a possible solution for visualizing temperature measurement in vivo based on their temperature sensitivity. However, temperature measurement and concentration imaging based on magnetic nanoparticles are still facing challenges in high-precision measurement and high spatial resolution imaging, while the detection capabilities of the current nuclear magnetic resonance spectrometers reach the ppm level. Therefore, a temperature measurement method capable of combining the temperature measurement principle of magnetic nanoparticles with the principle of a nuclear magnetic resonance spectrometer is sought to achieve high-precision visual temperature measurement in vivo.

### SUMMARY

The present disclosure aims to provide a concentration and temperature measurement method for magnetic nanoparticles based on paramagnetic shift, which can effectively realize concentration information and high-precision temperature measurement of the magnetic nanoparticles.

The concentration and temperature measurement method for magnetic nanoparticles based on paramagnetic shift comprises following steps.

(1) Add magnetic nanoparticles to a pure reagent as an experiment reagent to be tested.

(2) Place a pure reagent containing no magnetic nanoparticles and the experiment reagent containing magnetic nanoparticles in a nuclear magnetic resonance device with a uniform magnetic field intensity H₀, and perform test experiments on them to respectively obtain shifts of resonance absorption peaks of the pure reagent and the experiment reagent, i.e., chemical shifts δ_{R} and δ_{S}.

(3) According to the chemical shifts δ_{R} and δ_{S} of the pure reagent and the experiment reagent, acquire resonance frequencies ν_{R} and ν_{S} of the pure reagent and the experiment reagent.

(4) Substitute the resonance frequencies ν_{R} and ν_{S} of the pure reagent and the experiment reagent into a calculation formula of magnetic susceptibility of the magnetic nanoparticles

$${χ}_{S} = \frac{{υ}_{S} - {υ}_{R}}{{υ}_{0}} / ( \frac{4 π}{3} - α ) + {χ}_{R} ,$$

where χ_{S} and χ_{R} represent magnetic susceptibilities of the magnetic nanoparticles and the pure reagent, respectively; when the sample direction is perpendicular to the magnetic field direction, α=2 π; and when the sample direction is parallel to the magnetic field direction, α=0.

(5) Construct a magnetization and temperature sensitivity characteristic equation of the magnetic nanoparticles under the excitation of the static magnetic field

$${χ}_{s} = {NM}_{s} ( coth \frac{{M}_{s} VH}{kT} - \frac{kT}{{M}_{s} VH} ) / H ,$$

where Mₛ represents saturation magnetization of the magnetic nanoparticles, N represents a number of magnetic nanoparticles per unit volume, V represents a volume of the magnetic nanoparticles, H represents excitation magnetic field intensity, k represents the Boltzmann constant, and T represents temperature.

(6) By changing the magnetic field intensity H₀, construct a plurality of magnetization and temperature sensitivity characteristic equations of the magnetic nanoparticles under the excitation of the static magnetic field according to the steps (2)-(5), and simultaneously solve the equations to obtain a concentration N and a temperature T of the magnetic nanoparticles.

Further, in the step (3), the chemical shifts δ_{R} and δ_{S} of the pure reagent and the experiment reagent are respectively substituted into a formula

$${δ}_{i} = \frac{{υ}_{i} - {υ}_{0}}{{υ}_{0}} \times {10}^{6} , i = R , S$$

to solve for resonance frequencies ν_{R} and ν_{S} of the pure reagent and the experiment reagent, where ν₀ represents a resonance frequency of an internal standard of tetramethylsilane in the nuclear magnetic resonance device under its uniform magnetic field.

Further, the step (6) specifically includes the following.

Expand the magnetization and temperature sensitivity characteristic equation of the magnetic nanoparticles under the excitation of the static magnetic field

$${χ}_{s} = {NM}_{s} ( coth \frac{{M}_{s} VH}{kT} - \frac{kT}{{M}_{s} VH} ) / H$$

according to the Langevin function to obtain the magnetic susceptibility of the magnetic nanoparticles:

$${χ}_{s} = x ( \frac{1}{3} y - \frac{{H}^{2}}{45} {y}^{3} + \frac{2 {H}^{4}}{945} {y}^{5} - \frac{{H}^{6}}{4725} {y}^{7} + … ) ,$$

where x=NMₛ, y=MₛV/kT.

Construct a system of n nonlinear equations about temperature by using n different excitation magnetic fields Hᵢ and measured corresponding magnetic susceptibilities χₛᵢ,

$$\{ \begin{matrix}{χ}_{s 1} = x ( \frac{1}{3} y - \frac{{H}_{1}^{2}}{45} {y}^{3} + \frac{2 {H}_{1}^{4}}{945} {y}^{5} - \frac{{H}_{1}^{6}}{4725} {y}^{7} + … ) \\ {χ}_{s 2} = x ( \frac{1}{3} y - \frac{{H}_{2}^{2}}{45} {y}^{3} + \frac{2 {H}_{2}^{4}}{945} {y}^{5} - \frac{{H}_{2}^{6}}{4725} {y}^{7} + … ) , \\ {χ}_{s n} = x ( \frac{1}{3} y - \frac{{H}_{n}^{2}}{45} {y}^{3} + \frac{2 {H}_{n}^{4}}{945} {y}^{5} - \frac{{H}_{n}^{6}}{4725} {y}^{7} + … )\end{matrix} \\ where let Y = [ \begin{matrix}{χ}_{s 1} \\ {χ}_{s 2} \\ ⋮ \\ {χ}_{sn}\end{matrix} ] , \\ A = [ \begin{matrix}\frac{1}{3} & - \frac{{H}_{1}^{2}}{45} & \frac{2 {H}_{1}^{4}}{945} & - \frac{{H}_{1}^{6}}{4725} & … \\ \frac{1}{3} & - \frac{{H}_{2}^{2}}{45} & \frac{2 {H}_{2}^{4}}{945} & - \frac{{H}_{2}^{6}}{4725} & … \\ ⋮ & ⋮ & ⋮ & ⋮ & \\ \frac{1}{3} & - \frac{{H}_{n}^{2}}{45} & \frac{2 {H}_{n}^{4}}{945} & - \frac{{H}_{n}^{6}}{4725} & …\end{matrix} ] , and \\ X = [ \begin{matrix}xy \\ {xy}^{3} \\ {xy}^{5} \\ ⋮\end{matrix} ] ;$$

Solve for X* by a singular value decomposition inversion method, and then solve for y* by using first and second terms in the vector X*, that is,

$${y}^{*} = {( \frac{{X}^{*} ( 2 )}{{X}^{*} ( 1 )} )}^{\frac{1}{2}} ,$$

thereby obtaining a solution for temperature

$${T}^{*} = \frac{{M}_{s} V / k}{{y}^{*}}$$

and a solution for concentration

$${N}^{*} = \frac{1}{k \cdot {y}^{*} \cdot T} .$$

The present disclosure has the following beneficial effects.

A nuclear magnetic resonance device is utilized to measure chemical shifts of a liquid sample containing the paramagnetic particles to perform magnetic nanoparticle concentration and temperature measurement, thereby efficiently achieving high-accuracy concentration and temperature measurement. Paramagnetic magnetic nanoparticles are added to the nuclear paramagnetic resonance sample reagent, and paramagnetic shifts of the sample are obtained by nuclear magnetic resonance. Resonance frequencies are obtained by the paramagnetic shifts, magnetic susceptibilities are obtained according to the relationship between the resonance frequencies and the magnetic susceptibilities of the magnetic nanoparticles, and then the concentration information and temperature information of the sample are obtained by inverse solution according to the relationship between the magnetic susceptibility and the concentration and temperature of the magnetic nanoparticles. From the simulation data, concentration measurement and high-precision temperature measurement of the magnetic nanoparticle samples can be effectively realized by the paramagnetic displacement information.

### BRIEF DESCRIPTION OF THE DRAWINGS

FIG. 1 is a flow chart of a method according to the present disclosure.

FIG. 2 is a simulation diagram of nuclear magnetic resonance (NMR) paramagnetic shifts of magnetic nano samples of the same concentration at respective magnetic field intensities of 200 Gs, 300 Gs and 400 Gs as a function of temperature.

FIG. 3 is a simulation diagram of nuclear magnetic resonance (NMR) paramagnetic shifts of magnetic nano samples at the same temperature and respective magnetic field intensities of 200 Gs, 300 Gs and 400 Gs as a function of concentration.

FIG. 4 is a diagram showing a comparison of temperature results of magnetic nano samples obtained by inversion at respective magnetic fields of 200 Gs, 300 Gs and 400 Gs and a standard temperature.

FIG. 5 is a simulation diagram of temperature errors obtained by inversion at respective magnetic fields of 200 Gs, 300 Gs and 400 Gs.

### DETAILED DESCRIPTION OF THE EMBODIMENTS

For clear understanding of the objectives, features and advantages of the present disclosure, detailed description of the present disclosure will be given below in conjunction with accompanying drawings and specific embodiments. It should be noted that the embodiments described herein are only meant to explain the present disclosure, and not to limit the scope of the present disclosure.

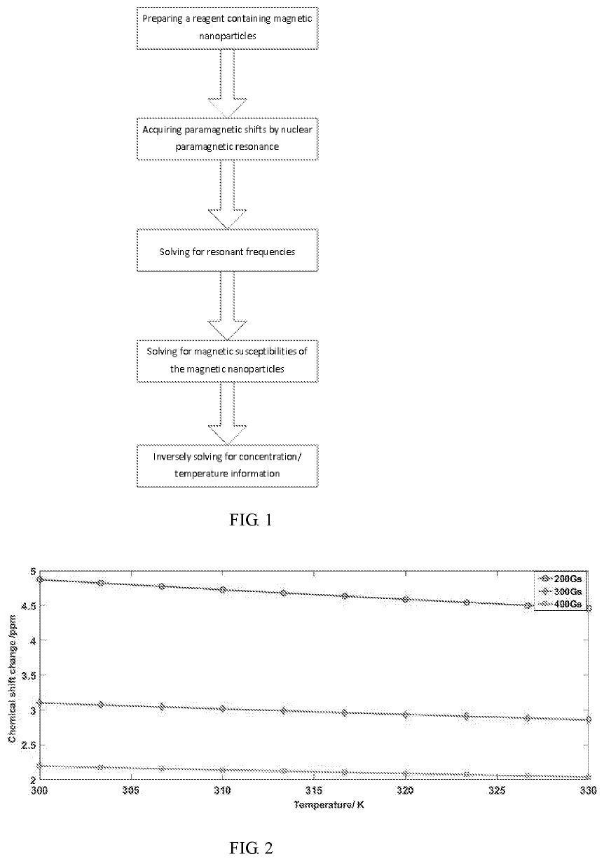

As shown in FIG. 1, the present disclosure provides a concentration and temperature measurement method for magnetic nanoparticles based on paramagnetic shift, comprising following steps.

(1) Select a kind of magnetic nanoparticles with appropriate particle size, and add the magnetic nanoparticles to a pure reagent as an experiment reagent with appropriate concentration to be tested. In the early stage, different concentrations of reagents containing magnetic nanoparticles are measured to select a magnetic nanoparticle reagent with the highest concentration as possible without seriously damaging the uniformity of the spatial magnetic field of the nuclear magnetic resonance device.

(2) place a reagent containing no magnetic nanoparticles and the experiment reagent containing magnetic nanoparticles in a nuclear magnetic resonance device with a magnetic field intensity H₀, and perform test experiments on them to respectively obtain shifts of resonance absorption peaks of the pure reagent and the experiment reagent, i.e., chemical shifts δ_{R} and δ_{S}.

A nuclear magnetic resonance device with a magnetic field intensity H₀ is used to respectively perform test experiments on the pure reagent and the experiment reagent containing magnetic nanoparticles to obtain chemical shifts δ_{R} and δ_{S}, in which the chemical shift δ_{R} of the pure reagent is used as a reference value.

The nuclear magnetic resonance device can use the existing nuclear magnetic resonance spectrometer with the measurement accuracy up to the ppm level. Since measurement is performed by the existing nuclear magnetic resonance spectrometer with the measurement accuracy up to the ppm level, higher precision concentration and temperature measurement of the magnetic nanoparticles can be achieved.

(3) According to the chemical shift δ of a sample, the frequency ν₀ of the nuclear magnetic resonance device, and a calculation formula of the chemical shift

$${δ}_{i} = \frac{{υ}_{i} - {υ}_{0}}{{υ}_{0}} \times {10}^{6} , i = R , S ,$$

solve the calculation formula to respectively obtain resonance frequencies ν_{R} and ν_{S} of the pure reagent and the experiment reagent.

According to the chemical shift δ of the sample, the frequency ν₀ of the nuclear magnetic resonance device, and a calculation formula of the chemical shift

$${δ}_{i} = \frac{{υ}_{i} - {υ}_{0}}{{υ}_{0}} \times {10}^{6} , i = R , S ,$$

resonance frequencies ν_{R} and ν_{S} of the pure reagent and the experiment reagent can be respectively obtained by solving the calculation formula. In actual temperature measurement, the amount of change Δν=ν_{S}−ν_{R} in resonant frequency caused by the magnetic nanoparticles is used, in which ν₀ represents a resonance frequency of an internal standard of tetramethylsilane (TMS) of the nuclear magnetic resonance equipment at its uniform magnetic field.

(4) substitute the resonance frequencies ν_{R} and ν_{S} of the pure reagent and the experiment reagent into a calculation formula

$${χ}_{S} = \frac{{υ}_{S} - {υ}_{R}}{{υ}_{0}} / ( \frac{4 π}{3} - α ) + {χ}_{R} ,$$

where χ_{S} and χ_{R} represent the magnetic susceptibilities of the magnetic nanoparticles and the pure reagent, respectively, a value of a is usually determined by the geometry of the sample and the relative direction of the sample tube and the external magnetic field: when the sample direction is perpendicular to the magnetic field direction, α=2 π, and when the sample direction is parallel to the magnetic field direction, α=0.

(5) According to the fact that the magnetization of the magnetic nanoparticles has temperature sensitivity under the excitation of static magnetic field, construct a magnetization and temperature sensitivity characteristic equation

$${χ}_{s} = {NM}_{s} ( coth \frac{{M}_{s} VH}{kT} - \frac{kT}{{M}_{s} VH} ) / H ,$$

where Mₛ, represents the saturation magnetization of the magnetic nanoparticles, N represents the number of magnetic nanoparticles per unit volume, V represents the volume of the magnetic nanoparticles, H represents the excitation magnetic field intensity, k represents the Boltzmann constant, and T represents the temperature.

The equation can be expanded according to the Langevin function to obtain:

$${χ}_{s} = x ( \frac{1}{3} y - \frac{{H}^{2}}{45} {y}^{3} + \frac{2 {H}^{4}}{945} {y}^{5} - \frac{{H}^{6}}{4725} {y}^{7} + … )$$

where x=NMₛ, y=MₛV/kT.

By using different excitation magnetic fields Hᵢ and measured corresponding magnetic susceptibilities χₛᵢ, a nonlinear equation system for temperature can be constructed:

$$\{ \begin{matrix}{χ}_{s 1} = x ( \frac{1}{3} y - \frac{{H}_{1}^{2}}{45} {y}^{3} + \frac{2 {H}_{1}^{4}}{945} {y}^{5} - \frac{{H}_{1}^{6}}{4725} {y}^{7} + … ) \\ {χ}_{s 2} = x ( \frac{1}{3} y - \frac{{H}_{2}^{2}}{45} {y}^{3} + \frac{2 {H}_{2}^{4}}{945} {y}^{5} - \frac{{H}_{2}^{6}}{4725} {y}^{7} + … ) \\ ⋮ \\ {χ}_{sn} = x ( \frac{1}{3} y - \frac{{H}_{n}^{2}}{45} {y}^{3} + \frac{2 {H}_{n}^{4}}{945} {y}^{5} - \frac{{H}_{n}^{6}}{4725} {y}^{7} + … )\end{matrix} \\ Let Y = [ \begin{matrix}{χ}_{s 1} \\ {χ}_{s 2} \\ ⋮ \\ {χ}_{sn}\end{matrix} ] , \\ A = [ \begin{matrix}\frac{1}{3} & - \frac{{H}_{1}^{2}}{45} & \frac{2 {H}_{1}^{4}}{945} & - \frac{2 {H}_{1}^{6}}{4725} & … \\ \frac{1}{3} & - \frac{{H}_{2}^{2}}{45} & \frac{2 {H}_{2}^{4}}{945} & - \frac{{H}_{2}^{6}}{4725} & … \\ ⋮ & ⋮ & ⋮ & ⋮ & \\ \frac{1}{3} & - \frac{{H}_{n}^{2}}{45} & \frac{2 {H}_{n}^{4}}{945} & - \frac{{H}_{n}^{6}}{4725} & …\end{matrix} ] , and \\ X = [ \begin{matrix}xy \\ {xy}^{3} \\ {xy}^{5} \\ ⋮\end{matrix} ] ,$$

then a singular value decomposition (SVD) inversion method can be used to solve for X*, then first and second terms in the vector X* can be used to solve for

$${y}^{*} = {( \frac{{X}^{*} ( 2 )}{{X}^{*} ( 1 )} )}^{\frac{1}{2}} ,$$

thereby obtaining a solution of temperature

$${T}^{*} = \frac{{M}_{s} V / k}{{y}^{*}}$$

and a solution of concentration

$${N}^{*} = \frac{1}{k \cdot {y}^{*} \cdot T} .$$

Simulation Example (Concentration and Temperature Solution):

1. Simulation Model and Test Description

In order to study the feasibility of the magnetic nanoparticle temperature measurement method based on paramagnetic shift, nuclear magnetic resonance paramagnetic shifts of the samples containing magnetic nanoparticles at respective static magnetic field intensities of 200 Gs, 300 Gs and 400 Gs as a function of temperature are simulated, in which the temperature T changes uniformly from 300 K to 330 K, totaling 30 temperature points; the number of magnetic nanoparticles is N0=1 mmol, and the concentration N changes uniformly from 0.1 N0 to 0.7 N0, totaling 7 concentration points.

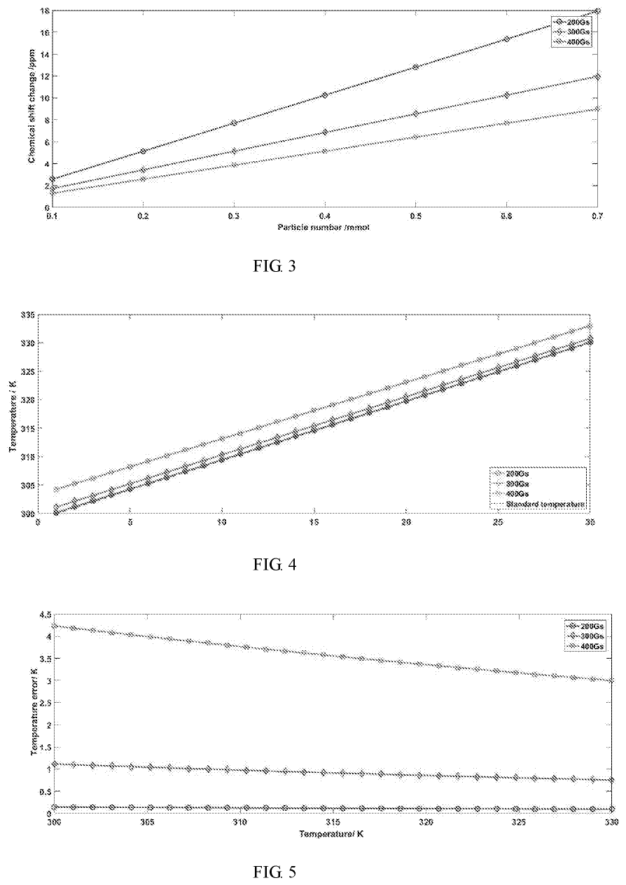

In the simulation, TMS is used as the nuclear magnetic standard substance, and the nuclear magnetic resonance sample is parallel to the magnetic field direction, that is, α=0. Relevant simulation parameters of the magnetic nanoparticles are: magnetic nanoparticle size d=10 nm, saturation magnetization Ms=314400 A/m, k=1.38*10\hat{ }(−23). Results of the paramagnetic shifts of samples of the same concentration at different magnetic field intensities as a function of temperature are shown in FIG. 2. Results of NMR paramagnetic shifts of magnetic nano samples at the same temperature as a function of concentration are shown in FIG. 3.

According to the temperature and concentration solution steps, the temperature information at a concentration of 0.1 mmol is shown in FIG. 4, and the temperature error is shown in FIG. 5.

2. Simulation Test Results

FIG. 4 shows the standard temperature and the temperature information of 10 nm magnetic nanoparticles obtained by inverse solution at respective static magnetic field intensities of 200 Gs, 300 Gs and 400 Gs. The concentration obtained by inverse solution was 0.1009 mmol, and the simulation concentration was set to 0.1 mmol.

FIG. 5 shows temperature measurement errors of 10 nm magnetic nanoparticles obtained by inverse solution at respective static magnetic fields intensities of 200 Gs, 300 Gs, and 400 Gs.

It can be seen from the results that when the magnetic field intensity is 200 Gs, and the temperature measurement error is within 0.15 K. However, as the static magnetic field intensity increases, the temperature measurement error increases. The reason for this phenomenon is that on the one hand, the magnetic susceptibility-temperature curve of the magnetic nanoparticles itself has the magnetic field modulation characteristic, which makes the curve have a certain translation phenomenon under different excitation magnetic fields, and the translation amount is related to the excitation field intensity; and on the other hand, the truncation error of the Taylor expansion of the Langevin function gradually increases.

The simulation results show that the concentration and temperature measurement of magnetic nanoparticles can be effectively realized by using the NMR paramagnetic shift of the magnetic nanoparticles.

1. A concentration and temperature measurement method for magnetic nanoparticles based on paramagnetic shift, characterized by comprising following steps of:
(1) adding magnetic nanoparticles to a pure reagent as an experiment reagent to be tested;
(2) placing a pure reagent containing no magnetic nanoparticles and the experiment reagent containing magnetic nanoparticles in a nuclear magnetic resonance device with a uniform magnetic field intensity H₀, and performing test experiments on them to respectively obtain shifts of resonance absorption peaks of the pure reagent and the experiment reagent, i.e., chemical shifts δ_{R} and δ_{S};
(3) according to the chemical shifts δ_{R} and δ_{S} of the pure reagent and the experiment reagent, acquiring resonance frequencies ν_{R} and ν_{S} of the pure reagent and the experiment reagent;
(4) substituting the resonance frequencies ν_{R} and ν_{S} of the pure reagent and the experiment reagent into a calculation formula of magnetic susceptibility of the magnetic nanoparticles
$${χ}_{S} = \frac{\frac{{υ}_{S} - {υ}_{R}}{{υ}_{0}}}{( \frac{4 π}{3} - α )} + {χ}_{R} ,$$
where χ_{S} and χ_{R} represents magnetic susceptibilities of the magnetic nanoparticles and the pure reagent, respectively; when the sample direction is perpendicular to the magnetic field direction, α=2 π; and when the sample direction is parallel to the magnetic field direction, α=0;
(5) constructing a magnetization and temperature sensitivity characteristic equation of the magnetic nanoparticles under the excitation of the static magnetic field
$${χ}_{s} = {NM}_{s} ( coth \frac{{M}_{s} VH}{kT} - \frac{kT}{{M}_{s} VH} ) / H ,$$
where Mₛ represents saturation magnetization of the magnetic nanoparticles, N represents a number of magnetic nanoparticles per unit volume, V represents volume of the magnetic nanoparticles, H represents excitation magnetic field intensity, k represents the Boltzmann constant, and T represents temperature.
(6) by changing the magnetic field intensity H₀, constructing a plurality of magnetization and temperature sensitivity characteristic equations of the magnetic nanoparticles under the excitation of the static magnetic field according to the steps (2)-(5), and simultaneously solving the equations to obtain a concentration N and a temperature T of the magnetic nanoparticles.

2. The concentration and temperature measurement method for the magnetic nanoparticles based on paramagnetic shift according to claim 1, characterized in that in the step (3), the chemical shifts δ_{R} and δ_{S} of the pure reagent and the experiment reagent are respectively substituted into a formula
$${δ}_{i} = \frac{{υ}_{i} - {υ}_{0}}{{υ}_{0}} \times {10}^{6} , i = R , S$$
to solve for resonance frequencies ν_{R} and ν_{S} of the pure reagent and the experiment reagent, where ν₀ represents a resonance frequency of an internal standard of tetramethylsilane in the nuclear magnetic resonance device under its uniform magnetic field.

3. The concentration and temperature measurement method for the magnetic nanoparticles based on paramagnetic shift according to claim 1, characterized in that the step (6) specifically includes:
expanding the magnetization and temperature sensitivity characteristic equation of the magnetic nanoparticles under the excitation of the static magnetic field
$${χ}_{s} = {NM}_{s} ( coth \frac{{M}_{s} VH}{kT} - \frac{kT}{{M}_{s} VH} ) / H$$
according to the Langevin function to obtain the magnetic susceptibility of the magnetic nanoparticles:
$${χ}_{s} = x ( \frac{1}{3} y - \frac{{H}^{2}}{45} {y}^{3} + \frac{2 {H}^{4}}{945} {y}^{5} - \frac{{H}^{6}}{4725} {y}^{7} + … ) ,$$
where x=NMₛ, y=MₛV/kT;
constructing a system of n nonlinear equations about temperature by using n different excitation magnetic fields Hᵢ and measured corresponding magnetic susceptibilities χₛᵢ,
$$\{ \begin{matrix}{χ}_{s 1} = x ( \frac{1}{3} y - \frac{{H}_{1}^{2}}{45} {y}^{3} + \frac{2 {H}_{1}^{4}}{945} {y}^{5} - \frac{{H}_{1}^{6}}{4725} {y}^{7} + … ) \\ {χ}_{s 2} = x ( \frac{1}{3} y - \frac{{H}_{2}^{2}}{45} {y}^{3} + \frac{2 {H}_{2}^{4}}{945} {y}^{5} - \frac{{H}_{2}^{6}}{4725} {y}^{7} + … ) \\ ⋮ \\ {χ}_{sn} = x ( \frac{1}{3} y - \frac{{H}_{n}^{2}}{45} {y}^{3} + \frac{2 {H}_{n}^{4}}{945} {y}^{5} - \frac{{H}_{n}^{6}}{4725} {y}^{7} + … )\end{matrix} , \\ where let \\ Y = [ \begin{matrix}{χ}_{s 1} \\ {χ}_{s 2} \\ ⋮ \\ {χ}_{sn}\end{matrix} ] , \\ A = [ \begin{matrix}\frac{1}{3} & - \frac{{H}_{1}^{2}}{45} & \frac{2 {H}_{1}^{4}}{945} & - \frac{2 {H}_{1}^{6}}{4725} & … \\ \frac{1}{3} & - \frac{{H}_{2}^{2}}{45} & \frac{2 {H}_{2}^{4}}{945} & - \frac{{H}_{2}^{6}}{4725} & … \\ ⋮ & ⋮ & ⋮ & ⋮ & \\ \frac{1}{3} & - \frac{{H}_{n}^{2}}{45} & \frac{2 {H}_{n}^{4}}{945} & - \frac{{H}_{n}^{6}}{4725} & …\end{matrix} ] , and \\ X = [ \begin{matrix}xy \\ {xy}^{3} \\ {xy}^{5} \\ ⋮\end{matrix} ] ;$$
solving for X* by a singular value decomposition inversion method, and then solving for y* by using first and second terms in the vector X*, that is,
$${y}^{*} = {( \frac{{X}^{*} ( 2 )}{{X}^{*} ( 1 )} )}^{\frac{1}{2}} ,$$
thereby obtaining a solution of temperature
$${T}^{*} = \frac{{M}_{s} V / k}{{y}^{*}}$$
and a solution of concentration
$${N}^{*} = \frac{1}{k \cdot {y}^{*} \cdot T} .$$
